(19) United States
(12) Patent Application Publication
(10) Pub. No.: US 2012/0214037 A1
(43) Pub. Date: Aug. 23, 2012

(54) LITHIUM SECONDARY BATTERY

(76) Inventors: Tomitaro Hara, Okazaki-shi (JP); Takuichi Arai, Toyota-shi (JP); Daisuke Teramoto, Toyota-shi (JP); Sachie Yusa, Okazaki-shi (JP)

(21) Appl. No.: 13/503,923

(22) PCT Filed: Sep. 17, 2010
(86) PCT No.: PCT/JP2010/066230

§ 371 Date: Apr. 25, 2012

(30) Foreign Application Priority Data
Oct. 30, 2009 (JP) 2009-250050

(51) Int. Cl. H01M 2/02; H01M 4/00

(52) U.S. Cl. 429/94; 429/163

(57) ABSTRACT

The present invention provides a lithium secondary battery having: an electrode body (80) that is made up of a positive electrode having a positive electrode active material layer that has a positive electrode active material on the surface of a positive electrode collector, a negative electrode having a negative electrode active material layer that has a negative electrode active material on the surface of a negative electrode collector, and a separator disposed between the positive electrode and the negative electrode; and a metallic battery case (50) that houses the electrode body and an electrolyte solution; wherein either the positive electrode or the negative electrode is electrically connected to the battery case (50), and a electric resistance value of the electrode active material layer of the electrode on a side not conductively connected to the case (50) is 90-fold or greater than the electric resistance value of the electrode active material layer of the electrode on a side conductively connected to the case (50).

### TECHNICAL FIELD

The present invention relates to a lithium secondary battery, and more particularly, to a lithium secondary battery having an electrode body provided with a positive electrode and a negative electrode and a battery case that houses the electrode body together with an electrolyte solution.

The present application claims priority to Japanese Patent Application Publication No. 2009-250050, filed on Oct. 30, 2009, the entire contents of which are incorporated herein by reference.

### BACKGROUND ART

Batteries (typically, secondary batteries) such as lithium ion batteries have gained importance in recent years as power sources installed in vehicles, or power sources in personal computers, cell phones and the like. In particular, lightweight lithium ion batteries that afford high-energy density hold promise as preferred high-output power sources in vehicles (for instance, Patent document 4).

Such lithium ion batteries can be expected to generate abnormal heat when shorts occur in the battery, or upon deformation of the battery through impacts caused by dropping or the like, or upon rupture of the battery through, for instance, penetration by a metallic nail. Increasing the resistance value between positive and negative electrodes has been studied as a means of suppressing such abnormal heat generation. For instance, Patent document 1 discloses a non-aqueous electrolyte secondary battery in which there is prescribed a value of 1.6 Ω·cm² or higher for the resistance value between electrodes upon superposition of the electrodes through direct contact between the surface of a positive electrode active material layer and the surface of a negative electrode active material layer. Thanks to the above configuration, short currents can be suppressed at short sites between the positive electrode and the negative electrode, even during abnormal situations such as internal shorts or the like. Patent documents 2 and 3 are other prior art documents that relate to such heat generation suppression.

Patent document 1: Laid-open Japanese Patent No. 2008-198591

Patent document 2: Laid-open Japanese Patent No. 2008-262832

Patent document 3: Laid-open Japanese Patent No. 2007-095421

Patent document 4: Laid-open Japanese Patent No. 2005-285447

### SUMMARY OF INVENTION

In the non-aqueous electrolyte secondary battery of Patent document 1, however, the negative electrode is connected to a battery case that doubles as a negative electrode terminal by way of a negative electrode lead. In this case the battery case has the potential of the negative electrode, and hence short currents can be suppressed at short sites between the positive electrode and the negative electrode during an abnormal situation, for instance during internal shorts. However, when the battery case and the positive electrode become electrically connected on account of, for instance, external impacts or metallic nail penetration, the short currents concentrate and flow in the battery case having the potential of the negative electrode, as a result of which the battery may experience abnormal heat generation. In the light of the above, it is an object of the present invention to provide a highly reliable lithium secondary battery in which battery faults (for instance, abnormal heat generation) during shorts can be suppressed.

The lithium secondary battery provided by the present invention comprises an electrode body that is made up of a positive electrode having a positive electrode active material layer that has a positive electrode active material on the surface of a positive electrode collector, a negative electrode having a negative electrode active material layer that comprises a negative electrode active material, on the surface of a negative electrode collector, and a separator disposed between the positive electrode and the negative electrode; and a metallic battery case that houses the electrode body together with an electrolyte solution. Either the positive electrode or the negative electrode is electrically connected to the battery case. An electric resistance value of the electrode active material layer of the electrode on a side not conductively connected to the case (hereafter, electrode on the side not conductively connected to the case) is 90-fold or greater than the electric resistance value of the electrode active material layer of the electrode on a side conductively connected to the case (hereafter, electrode on the side conductively connected to the case).

In the present description, the term “electric resistance value” denotes the surface resistance of an electrode active material layer (electric resistance in the thickness direction per unit surface area of the electrode active material layer). For instance, an electrode active material layer is clamped between voltage measurement terminals, and there is measured a resistance value upon flow of current while under application of a constant load from above and below the voltage measurement terminals. The surface resistance of the electrode active material layer is worked out on the basis of the measured resistance value R and the contact surface area S of the voltage measurement terminals, in accordance with the formula below.

Electric resistance value (Ω·cm²)=measured resistance value R (Ω)×contact surface area S (cm²).

In the lithium secondary battery according to the present invention, the electric resistance value of the electrode active material layer having an electrode on the side not conductively connected to the case is significantly larger (90-fold or more) than that of the other electrode. Therefore, the positive electrode active material layer on the side of high electric resistance value (side not conductively connected to the case) can function effectively as a resistive source of charge transfer, while rises in the internal resistance of the battery as a whole are suppressed, as compared with an instance where the electric resistance values of both electrode active material layers are increased. The electric resistance value of the electrode active material layer is large even upon occurrence of, for instance, direct contact between the case and the electrode active material layer of the electrode on the side not conductively connected to the case as a result of, for instance, crushing, metallic nail penetration or the like. Therefore, short current does not flow readily between the case and the electrode on the side not conductively connected to the case (and, by extension, significant current does not flow readily, via the case, between the electrode on the side conductively connected to the case and the electrode on the side not conductively connected to the case). As a result there is suppressed release of large currents at a short point, and problems associated with large current transfers are avoided. Therefore, the present invention succeeds in providing a highly reliable lithium secondary battery in which there can be suppressed battery faults that are associated with large current transfers during shorts.

The electric resistance value of the electrode active material layer on the side not conductively connected to the case may be 90-fold or more (typically, about 100-fold or more, for instance 99.5-fold or more), for instance 500-fold or more, and also 1000-fold or more, greater than the electric resistance value of the electrode active material layer on the side conductively connected to the case. The higher the difference (multiple) between the electric resistance values, the more effective is the suppression of current transfer during shorts. Although not particularly limited thereto, the upper limit of the multiple of the electric resistance value can be set to, for instance, 1×10⁸-fold or less (typically, 1×10⁶ -fold or less). The electric resistance value (surface resistance) of the electrode active material layer on the side not conductively connected to the case is preferably set to range from about 1 Ω·cm² to 10 Ω·cm², ordinarily from 1 Ω·cm² to about 5 Ω·cm². If the electric resistance value is excessively smaller than the above-mentioned ranges, a sufficient effect of suppressing current transfer during shorts may fail to be achieved. If the electric resistance value is excessively larger than the above-mentioned ranges, electric resistance increases in the electrodes, whereby battery performance may be impaired.

In a preferred aspect of the lithium secondary battery disclosed herein, the electrode on the side not conductively connected to the case is the positive electrode, and the positive electrode comprises, as a positive electrode active material, an olivine-type phosphate compound represented by formula LiMPO₄ (where M includes at least one metal element selected from the group consisting of Fe, Ni and Mn). Ordinarily, a positive electrode active material layer comprising a olivine-type phosphate compound has a comparatively large electric resistance value (for instance, as compared with positive electrode active material layers having, as a main component, a layered lithium transition metal oxide such as lithium nickel oxide), and can therefore by preferably used as a resistive source of charge transfer between the case and the electrode on the side not conductively connected to the case in an instance of direct contact between the case and the electrode active material layer on the side not conductively connected to the case. Olivine-type phosphate compounds have high thermal stability and a stable crystal structure, and hence the crystal structure is not readily destroyed on account of concentrated flow of a large current in case of hypothetical shorts. As a result, this allows suppressing, more reliably, generation of heat caused by the destruction of the positive electrode active material during shorts.

In a preferred aspect of the lithium secondary battery disclosed herein, the battery capacity of the lithium secondary battery is 10 Ah or higher. In such a large-capacity type lithium secondary battery, large current flow occurs at short sites, and the battery is thus susceptible to occurrence of battery faults (for instance, abnormal heat generation) that accompany large current transfers. The present invention is particularly useful in such a battery.

In a preferred aspect of the lithium secondary battery disclosed herein, the electrode body is a flat-shaped wound electrode body, and the battery case is a square-type case capable of housing the flat-shaped wound electrode body. A lithium secondary battery (typically, a lithium ion secondary battery) having a configuration in which such a flat-shaped wound electrode body is housed in a square-type case can easily be made into a large-capacity battery. Battery faults (for instance, abnormal heat generation) that accompany large current transfers during shorts are likely to occur in large-capacity batteries. Therefore, the present invention is particularly useful when used in such batteries (in particular, batteries having a battery capacity of 10 Ah or more).

Such a lithium secondary battery boasts good battery characteristics in that battery faults (abnormal heat generation and the like) during shorts are suppressed, as described above. Therefore, the battery of the present invention can be appropriately used as a power source installed in vehicles such as automobiles or the like. Therefore, the present invention provides a vehicle that comprises any of the lithium secondary batteries disclosed herein (and which may be embodied as a battery pack in which a plurality of batteries are connected). In particular, the present invention affords good output characteristics. A vehicle (for instance, an automobile) provided with such a lithium secondary battery as a power source (typically, a power source of a hybrid vehicle or an electric vehicle) can also be provided.

### BRIEF DESCRIPTION OF DRAWINGS

FIG. 1 is a perspective diagram illustrating schematically a battery according to one embodiment of the present invention;

FIG. 2 is a cross-sectional diagram along line II-II in FIG. 1;

FIG. 3 is a diagram illustrating schematically an electrode body of a battery according to one embodiment of the present invention;

FIG. 4 is a diagram illustrating schematically an electrode body of a battery according to one embodiment of the present invention;

FIG. 5 is an enlarged cross-sectional diagram illustrating a relevant portion of a battery according to one embodiment of the present invention;

FIG. 6 is a diagram for explaining a method for measuring a resistance value of an electrode active material layer in the present test example;

FIG. 7 is a perspective diagram illustrating schematically a battery according to the present test example;

FIG. 8 is a graph illustrating the relationship between highest-reached temperature and resistance ratio (multiple) in the present test example; and

FIG. 9 is a side-view diagram illustrating schematically a vehicle provided with a battery according to one embodiment of the present invention.

### DESCRIPTION OF EMBODIMENTS

Embodiments of the present invention are explained below with reference to accompanying drawings. In the explanation of the drawings, members and portions that elicit a same effect are denoted with identical reference numerals. The dimensional relationships (length, width, and thickness) in the figures do not reflect actual dimensional relationships. Any features other than the features specifically set forth in the present description and which may be necessary for carrying out the present invention (for instance, the configuration and manufacturing method of an electrode body that comprises a positive electrode and a negative electrode, the configuration and manufacturing method of a separator and an electrolyte, and ordinary techniques relating to the construction of lithium secondary batteries) can be regarded as design matter for a person skilled in the art on the basis of known techniques in the technical field in question.

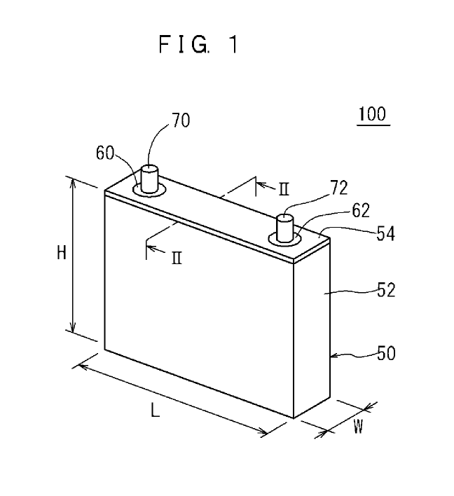

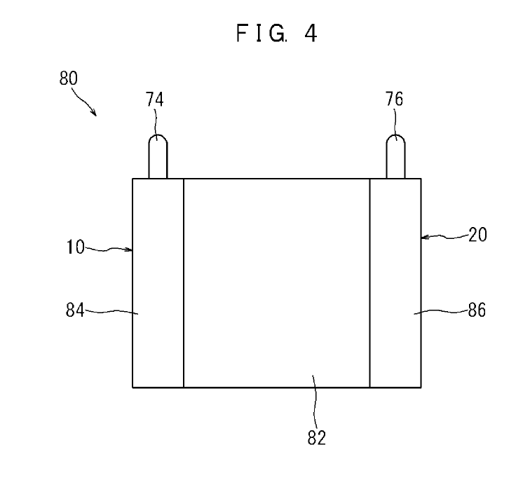

As illustrated in FIG. 1 to FIG. 4, a lithium secondary battery 100 of the present embodiment is made up of an electrode body 80 that comprises a positive electrode 10 having a positive electrode active material layer 14, comprising a positive electrode active material, on the surface of a positive electrode collector 12; a negative electrode 20 having a negative electrode active material layer 24, comprising a negative electrode active material, on the surface of a negative electrode collector 22; and a separator 40 disposed between the positive electrode 10 and the negative electrode 20. The lithium secondary battery 100 further comprises a metallic battery case 50 in which the electrode body 80 is housed together with an electrolyte solution not shown.

Either the positive electrode 10 or the negative electrode 20 is electrically (conductively) connected to the battery case 50. In the present embodiment, the electrode on the side conductively connected to the case is the negative electrode 20, and the electrode on the side not conductively connected to the case is the positive electrode 10. The electric resistance value of the positive electrode active material layer 14 comprised in the positive electrode 10 on the side not conductively connected to the case is set to be 100-fold or more greater than the electric resistance value of the negative electrode active material layer 24 comprised in the negative electrode 20 on the side conductively connected to the case.

In the lithium secondary battery 100 according to the present embodiment, the electric resistance value of the positive electrode active material layer 14 in the positive electrode 10 on the side not conductively connected to the case is significantly (100-fold or more) greater than that of the negative electrode active material layer 24. Therefore, the positive electrode active material layer 14 on the side of high electric resistance value (side not conductively connected to the case) can function effectively as a resistive source of charge transfer, while rises in the internal resistance of the battery as a whole are suppressed, as compared with a case in which the electric resistance values of both electrode active material layers are increased. Even upon occurrence of direct contact between the case 50 and the positive electrode active material layer 14 of the positive electrode 10 on the side not conductively connected to the case as a result of, for instance, crushing, metallic nail penetration or the like, the electric resistance value of the positive electrode active material layer 14 is large, and hence short current does not flow readily between the case 50 and the positive electrode 10 on the side not conductively connected to the case (and, by extension, substantial current does not flow readily, via the case 50, between the negative electrode 20 on the side conductively connected to the case and the positive electrode 10 on the side not conductively connected to the case). As a result, release of large current at a short point is suppressed, and problems associated with large current transfers (battery faults in the form of, for instance, abnormal heat generation in the battery) can be avoided. Therefore, the present embodiment allows providing a highly reliable lithium secondary battery 100 in which there can be suppressed battery faults that are associated with large current transfers during shorts.

Although not particularly limited thereto, the present invention is explained in detail next on the basis of an example of a lithium secondary battery (lithium ion battery) in which the flat wound electrode body (wound electrode body) 80 and a non-aqueous electrolyte solution are housed in the flat box-like (parallelepiped-shaped) battery case 50.

The lithium ion battery 100 has a configuration in which the electrode body (wound electrode body) 80, embodied through flat winding of the positive electrode sheet 10 and the elongate negative electrode sheet 20, via the elongate separator 40, is housed, together with a non-aqueous electrolyte solution not shown in the battery, in the case 50 having a shape capable of accommodating the wound electrode body 80.

The battery case 50 need only have a shape such that the electrode body 80 can be accommodated therein together with a non-aqueous electrolyte solution not shown. In a preferred application of the technology disclosed herein, for instance, the case 50 may be a flat square case 50 that can accommodate a flat-type wound electrode body 80. The case 50 comprises a battery case main body 52 shaped as a flat rectangular parallelepiped, the top end whereof is open, and a lid body 54 that plugs that opening portion. The material used to make up the battery case 50 is, preferably, a metallic material such as aluminum, nickel-plated copper, steel or the like (nickel-plated copper in the present embodiment). The above metallic materials have excellent heat dissipation ability, and are hence preferably used as the material of a battery case suitable for the purpose of the present invention.

A positive electrode terminal 70 electrically connected to the positive electrode 10 of the wound electrode body 80 is provided on the top face (i.e. lid body 54) of the battery case 50, via an insulating gasket 60. The positive electrode terminal 70 and the battery case 50 are electrically isolated from each other by the insulating gasket 60. A negative electrode terminal 72 electrically connected to the negative electrode 20 of the wound electrode body 80 is provided on the top face (i.e. lid body 54) of the battery case 50, via conductive spacer 62. The battery case 50 and the negative electrode terminal 72 (and hence the negative electrode 20) are electrically connected via the conductive spacer 62. As a result, the battery case 50 has the potential of the negative electrode 20. The flat-shaped wound electrode body 80 is housed, together with a non-aqueous electrolyte solution, not shown, inside the battery case 50.

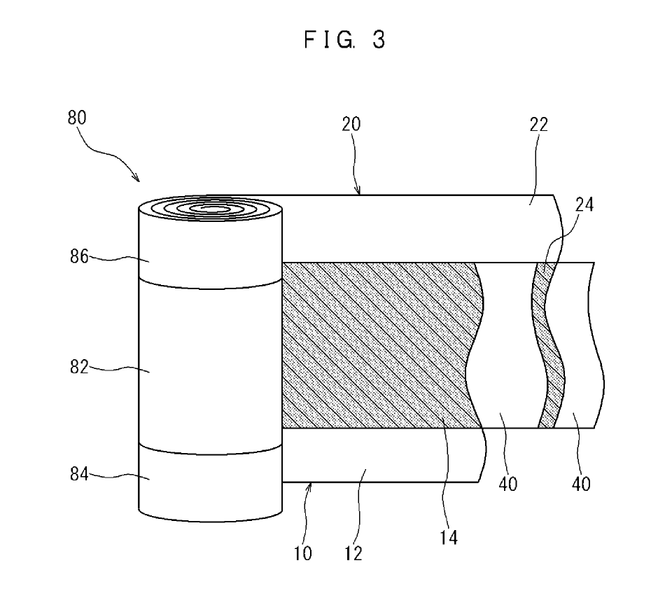

Similarly to electrode bodies in typical lithium secondary batteries, the electrode body 80 is made up of predetermined battery-constituting materials (active materials of the positive and negative electrodes, collectors of the positive and negative electrodes, separators and so forth). In a preferred application of the technology disclosed herein, the electrode body is a flat-shaped wound electrode body 80. The wound electrode body 80 is identical to wound electrode bodies in ordinary lithium secondary batteries, except for the relationship between the electric resistance values of the positive electrode 10 and the negative electrode 20. As illustrated in FIG. 3, the wound electrode body 80 has an elongate (band-like) sheet structure at a stage prior to assembly.

The positive electrode sheet 10 has a structure wherein the positive electrode active material layer 14 that comprises a positive electrode active material is held on both faces of the foil-like positive electrode collector (hereafter, “positive electrode collecting foil”) 12 shaped as an elongate sheet. The positive electrode active material layer 14 is not adhered to one side edge, in the width direction of the positive electrode sheet 10 (the lower side edge portion in the figure), such that there is formed a positive electrode active material layer non-formation portion where the positive electrode collector 12 is exposed over a given width.

In the same way as the positive electrode sheet 10, the negative electrode sheet 20 has a structure wherein the negative electrode active material layer 24 that comprises a negative electrode active material is held on both faces of the foil-like negative electrode collector (hereafter, “negative electrode collecting foil”) 22 shaped as an elongate sheet. However, the negative electrode active material layer 24 is not adhered to one side edge, in the width direction, of the negative electrode sheet 20 (upper side edge portion in the figure), such that there is formed a negative electrode active material layer non-formation portion where the negative electrode collector 22 is exposed over a given width.

To produce the wound electrode body 80, the positive electrode sheet 10 and the negative electrode sheet 20 are stacked, with the separator sheet 40 interposed in between. The positive electrode sheet 10 and the negative electrode sheet 20 are superposed slightly offset with respect to each other, in such a manner that the positive electrode active material layer non-formation portion of the positive electrode sheet 10 and the negative electrode active material layer non-formation portion of the negative electrode sheet 20 jut out of the separator sheet 40 on respective sides in the width direction. The stack thus formed is wound, and the obtained wound body is next squashed from the sides, to form a flat wound electrode body 80.

A wound core portion 82 (i.e. portion in which the positive electrode active material layer 14 of the positive electrode sheet 10, the negative electrode active material layer 24 of the negative electrode sheet 20, and the separator sheet 40 are closely stacked together) is formed in the central portion of the wound electrode body 80, in the winding axis direction. The electrode active material layer non-formation portions of the positive electrode sheet 10 and the negative electrode sheet 20 jut out of the wound core portion 82 at both end portions of the wound electrode body 80, in the winding axis direction. A positive electrode lead terminal 74 and a negative electrode lead terminal 76 are respectively provided on a positive electrode side jutting portion 84 (i.e. the non-formation portion of the positive electrode active material layer 14) and a negative electrode side jutting portion 86 (i.e. the non-formation portion of the negative electrode active material layer 24). The positive electrode lead terminal 74 and the negative electrode lead terminal 76 are electrically connected to the above-described positive electrode terminal 70 and negative electrode terminal 72, respectively.

The constituent elements that make up the wound electrode body 80 are not particularly limited, and may be the same as those in a wound electrode body of a conventional lithium ion battery, except for the positive electrode sheet 10. For instance, the negative electrode sheet 20 may be formed of the negative electrode active material layer 24, which has a main component in the form of a negative electrode active material for lithium ion batteries, on the elongate negative electrode collector 22. A copper foil or some other metal foil appropriate for negative electrodes is appropriately used as the negative electrode collector 22. The negative electrode active material that is used is not particularly limited and may be one, two or more types of materials used in conventional lithium ion batteries. Suitable examples thereof include, for instance, carbon-based materials such as graphite carbon, amorphous carbon or the like; lithium-containing transition metal oxides, transition metal nitrides or the like. In a preferred application of the technology disclosed herein, for instance, a copper foil having a length of about 2 m to 10 m (for instance, 5 m), a width of 6 cm to 20 cm (for instance, 8 cm) and a thickness of about 5 μm to 20 μm (for instance, 10 μm), is used as the negative electrode collector 22. Preferably, there can be used a negative electrode sheet 20 in which the negative electrode active material layer 24 having a thickness of about 40 μm to 300 μm (for instance, 80 μm) is formed, by a known method, at a predetermined region on both faces of the negative electrode collector 22.

The positive electrode sheet 10 can be formed by applying the positive electrode active material layer 14, having a positive electrode active material for lithium ion batteries as a main component, onto the elongate positive electrode collector 12. Aluminum foil or some other metal foil appropriate for positive electrodes is suitably used in the positive electrode collector 12. In a preferred application of the technology disclosed herein, for instance, an aluminum foil having a length of about 2 m to 10 m (for instance, 5 m), a width of 6 cm to 20 cm (for instance, 8 cm) and a thickness of about 5 μm to 20 μm (for instance, 15 μm) is used as the positive electrode collector 12. Preferably, there can be used a positive electrode sheet 10 in which the positive electrode active material layer 14 having a thickness of about 40 μm to 300 μm (for instance, 80 μm) is formed, by a known method, at a predetermined region on both faces of the positive electrode collector 12.

The positive electrode active material that is used is not particularly limited and may be one, two or more types of materials used in conventional lithium ion batteries. For instance, there can be used a layered oxide such as lithium nickel oxide (LiNiO₂), a spinel compound such as lithium manganese oxide (LiMn₂O₄), or a polyanionic compound such as lithium iron phosphate (LiFePO₄).

In a preferred application of the technology disclosed herein, there is used a positive electrode active material having, as a main component, a so-called olivine-type phosphate compound (for instance, LiFePO₄, LiMnPO₄ or the like) comprising lithium. Among the foregoing, there is preferably used a positive electrode active material having LiFePO₄ as a main component (typically, a positive electrode active material comprising substantially LiFePO₄). Ordinarily, a positive electrode active material layer 14 comprising an olivine-type phosphate compound has a comparatively large electric resistance value, and is therefore preferably used as a resistive source of charge transfer between the case 50 and the positive electrode 10, in such instances where shorts occur between the case 50 and the positive electrode active material layer 14 on the side not conductively connected to the case. Olivine-type phosphate compounds have high thermal stability (for instance, a pyrolysis temperature of about 1000° C.) and a stable crystal structure, and hence the crystal structure is not readily destroyed on account of concentrated flow of large current during hypothetical shorts. As a result, this allows suppressing, more reliably, generation of heat caused by the destruction of the positive electrode active material during shorts. Olivine-type phosphate compounds are typically represented by the formula LiMPO₄. In the formula, M denotes at least one transition metal element, for instance, one, two or more elements selected from among Mn, Fe, Co, Ni, Mg, Zn, Cr, Ti and V.

As such an olivine-type phosphate compound (typically, in particulate form) there can be used, for instance, an olivine-type phosphate compound powder prepared according to conventional methods, without further modification. As the positive electrode active material there can be preferably used, for instance, an olivine-type phosphate compound powder made up substantially of secondary particles having an average particle size ranging from about to 1 μm to 25 μm.

The positive electrode active material layer 14 may contain, as the case may require, one, two or more types of materials that can be used as constituent components of positive electrode active material layers in ordinary lithium ion batteries. Examples of such materials include, for instance, conductive materials. As the conductive material there can be preferably used a carbon material such as a carbon powder, carbon fibers or the like. Alternatively, there can be used, for instance, a conductive metal powder, such as a nickel powder. Other materials that can be used as components in the positive electrode active material layer include, for instance, various polymer materials that can function as a binder for the above-described constituent materials.

Although not particularly limited thereto, the proportion of positive electrode active material in the total positive electrode active material layer is preferably about 50 wt % or higher (typically, 50 to 95 wt %), and ranges preferably from about 75 to 90 wt %. In the positive electrode active material layer having a composition that comprises a conductive material, the proportion of conductive material in the positive electrode active material layer can range, for instance, from 3 to 25 wt %, preferably from about 3 to 15 wt %. In a case where, besides the positive electrode active material and the conductive material, other components (for instance, a polymer material) for forming the positive electrode active material layer are also present, the total content proportion of such arbitrary components is preferably no greater than about 7 wt %, and preferably no greater than about 5 wt % (for instance, from about 1 to 5 wt %).

As a method for forming the positive electrode active material layer 14 there can be used a method wherein a paste for forming a positive electrode active material layer, in which a positive electrode active material (typically, in granular form) and other components for forming a positive electrode active material layer are dissolved in an appropriate solvent (preferably, an aqueous solvent), is applied, in the form of a band, onto one face or both faces (in this case, both faces) of the positive electrode collector 12, followed by drying. After drying of the paste for forming a positive electrode active material layer, there is performed an appropriate pressing process (for instance, using a conventional known pressing method such as roll pressing, plate pressing or the like), to adjust thereby the thickness and the density of the positive electrode active material layer 14.

Examples of a separator sheet 40 that can be appropriately used between the positive and negative electrode sheets 10, 20 include, for instance, separator sheets made up of a porous polyolefin resin. In a preferred application of the technology disclosed herein, for instance, there can be preferably used a porous separator sheet made up of a synthetic resin (for instance, a polyolefin such as polyethylene) and having a length of about 2 m to 10 m (for instance, 3.1 m) a width of 8 cm to 20 cm (for instance, 11 cm) and a thickness of about 5 μm to 30 μm (for instance, 16 μm).

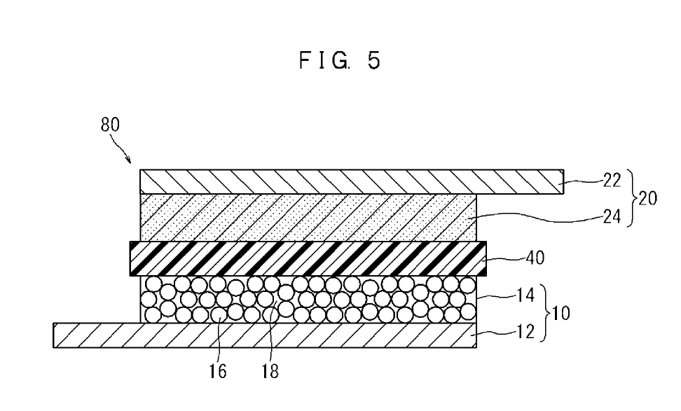

The positive electrode sheet 10 according to the present embodiment is explained in detail next with reference to FIG. 5. FIG. 5 is a schematic cross-sectional diagram illustrating an enlargement of a partial cross section, along the winding axis of the wound electrode body 80 according to the present embodiment. The figure illustrates the positive electrode collector 12, the positive electrode active material layer 14 formed on one side thereof, the negative electrode collector 22 and the negative electrode active material layer 24 formed on one side thereof, and the separator sheet 40 sandwiched between the positive electrode active material layer 14 and the negative electrode active material layer 24.

As illustrated in FIG. 5, the positive electrode active material layer 14 has a conductive agent (not shown) and positive electrode active material particles 16 made up substantially of secondary particles. The positive electrode active material particles 16 are fixed to each other, and the conductive agent are fixed to the positive electrode active material particles, by way of a binder not shown. The positive electrode active material layer 14 has spaces (pores) 18 through which a non-aqueous electrolyte solution seeps into the positive electrode active material layer 14. The spaces (pores) 18 can be formed, for instance, by voids between positive electrode active material particles 16 that are fixed to each other.

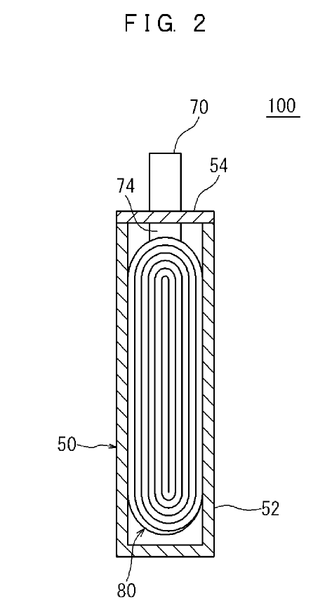

In the present embodiment, the positive electrode 10 or the negative electrode 20 is electrically connected to the battery case 50 (for instance, FIG. 2). In the present embodiment, the electrode on the side conductively connected to the case is the negative electrode 20, and the electrode on the side not conductively connected to the case is the positive electrode 10. The electric resistance value of the positive electrode active material layer 14 comprised in the positive electrode 10 on the side not conductively connected to the case is set to be 100-fold or more greater than the electric resistance value of the negative electrode active material layer 24 comprised in the negative electrode 20 on the side conductively connected to the case.

In a battery configured in such a manner that the negative electrode side, in which the electric resistance value of the electrode active material layer is comparatively small, is conductively connected to the case 50, thus, short current flows less readily at a contact point (short point) even if the electrode active material layer of the electrode, on the side not conductively connected to the case, comes into contact with the case 50, as compared with a battery configured in such a manner that the positive electrode 10, having a relatively large electric resistance value, is conductively connected to the case 50. Generation of heat in the battery can be suppressed as a result. In a battery configuration where the negative electrode 20 is conductively connected to the case 50, specifically, a large current flows between the case 50 and the negative electrode 20, via the electrode active material layer that has a relatively small electric resistance value (and accordingly, a large current flows between the negative electrode 20 and the positive electrode 10, via the case 50), upon occurrence of shorts between the case 50 and the negative electrode active material layer 24 on account of, for instance, crushing or metallic nail penetration. This may give rise to abnormal heat generation in the battery.

In the present embodiment, by contrast, the positive electrode side, wherein the electric resistance value of the electrode active material layer is relatively large, is conductively connected to the case 50. Therefore, the positive electrode active material layer 14, having a relatively large electric resistance value, becomes a resistive source of charge transfer and limits thereby short current between the case 50 and the positive electrode 10, even upon occurrence of shorts between the case 50 and the positive electrode active material layer 14 on account of crushing, metallic nail penetration or the like. Also, large currents do not flow readily between the negative electrode 20 and the positive electrode 10, via the case 50. As a result, large current transfers are suppressed in the battery, and there can be avoided battery faults, for instance abnormal heat generation that accompanies large current transfer.

The electric resistance value (surface resistance) of the positive electrode active material layer 14 may be set to 90-fold or more (typically, about 100-fold or more, for instance 99.5-fold or more), for instance 500-fold or more, or 1000-fold or more, greater than the electric resistance value of the negative electrode active material layer 24. The greater the difference between the electric resistance values of the positive and negative electrodes, the more pronounced becomes the suppressing effect on current transfer during shorts, and there can be obtained a more reliable lithium secondary battery. Although not particularly limited thereto, the upper limit of the multiple of the electric resistance value of the positive electrode active material layer 14 with respect to the electric resistance value of the negative electrode active material layer 24 can be set to be, for instance, 1×10⁸-fold or less (typically, 1×10⁶-fold or less). The electric resistance value (surface resistance) of the positive electrode active material layer 14 is preferably set to range from about 1 Ω·cm² to 10 Ω·cm², ordinarily from 1 Ω·cm² to 5 Ω·cm². If the electric resistance value is excessively smaller than the above-mentioned ranges, a sufficient effect of suppressing current transfer during shorts may fail to be achieved. If the electric resistance value is excessively larger than the above-mentioned ranges, electric resistance increases in the electrodes, whereby battery performance may be impaired.

The electric resistance value of the positive electrode active material layer 14 can be appropriately adjusted, for instance, by varying the type and/or addition amount of the conductive agent comprised in the positive electrode active material layer. Alternatively, the electric resistance value can be adjusted to lie within the appropriate ranges disclosed herein through modification of the packing factor of the positive electrode active material layer. The packing factor of the positive electrode active material layer is represented by {(total volume of positive electrode active material layer)−(volume of voids in positive electrode active material layer)}/(total volume of positive electrode active material layer)×100. A relatively smaller packing factor entails fewer contacts between material particles in the positive electrode active material layer, and, accordingly, a relatively larger electric resistance value. Therefore, the electric resistance value of the positive electrode active material layer can be adjusted by modifying the packing factor of the positive electrode active material layer. Specifically, a paste for forming a positive electrode active material layer is applied onto the positive electrode collector 12 and is dried, after which the thickness, density and packing factor of the positive electrode active material layer 14 is adjusted by way of an appropriate pressing (compression) treatment. The electric resistance value of the positive electrode active material layer 14 can be adjusted to lie within the appropriate ranges disclosed herein through modification of the press pressure. The electric resistance value of the negative electrode active material layer 24 can be appropriately adjusted in the same way as in the positive electrode active material layer.

The wound electrode body 80 having such a configuration is housed into the battery case main body 52, and an appropriate non-aqueous electrolyte solution is provided (poured) in the battery case main body 52. The non-aqueous electrolyte solution that is housed in the battery case main body 52 together with the wound electrode body 80 is not particularly limited, and there may be used an non-aqueous electrolyte solution identical to those used in conventional lithium ion batteries. Such a non-aqueous electrolyte solution has typically a composition that comprises a supporting salt in an appropriate non-aqueous solvent.

Examples of the non-aqueous solvent include, for instance, ethylene carbonate (EC), ethyl methyl carbonate (EMC), dimethyl carbonate (DMC), diethyl carbonate (DEC), propylene carbonate (PC) or the like. As the supporting salt there can be preferably used, for instance, a lithium salt such as LiPF₆, LiBF₄, LiAsF₆, LiCF₃SO₃ or the like. For instance, there can be preferably used a non-aqueous electrolyte solution that comprises LiPF₆, as a supporting salt, in a concentration of about 1 mol/L, in a mixed solvent of EC, EMC and DMC at a 3:4:3 volume ratio.

The above non-aqueous electrolyte solution is accommodated in the battery case main body 52 together with the wound electrode body 80, and the opening portion of the battery case main body 52 is sealed through, for instance, welding with the lid body 54, which completes the construction (assembly) of the lithium ion battery 100 according to the present embodiment. The process of sealing the battery case main body 52 and the process of providing (pouring) the electrolyte solution can be accomplished in accordance with methods identical to those of conventional lithium ion batteries. Thereafter, the battery is conditioned (initial charge and discharge). Other process, such as gas bleeding, quality inspection and the like may also be carried out, as needed.

A preferred application of the technology disclosed herein is a lithium secondary battery (typically, a lithium ion battery) of comparatively large capacity type, i.e. having a battery capacity of 10 Ah or more. Examples thereof include, for instance, large-capacity lithium secondary batteries having a battery capacity of 10 Ah or more (typically, 20 Ah or more, up to 100 Ah), or a battery capacity of 30 Ah or more (for instance, 50 Ah or more, typically up to 100 Ah). In such a large-capacity type lithium secondary battery, large current flow occurs at short sites, and the battery is thus is susceptible to occurrence of battery faults (for instance, abnormal heat generation) that accompany large current transfers. The present invention is particularly useful in such a battery. Such large-capacity type lithium secondary batteries are useful as batteries installed in, for instance, hybrid-electric automobiles.

A preferred application of the technology disclosed herein is a lithium ion secondary battery having a configuration in which the flat wound electrode body 80 is housed in the square-type case 50 (battery case main body 52 and lid body 54). Although not particularly limited thereto, as shown in FIG. 1 the lid body 54 of the present embodiment has a rectangular plate-like shape 15 cm long (L=15 cm) and 2 cm wide (W=2 cm) (thickness 1 mm). The case main body 52 of the present embodiment has a box-like shape 15 cm long (L =15 cm), 2 cm wide (W=2 cm) and 10 cm high (H=10 cm) (thickness 1 mm). A lithium secondary battery having a configuration in which such a flat-shaped wound electrode body 80 is housed in the square-type case 50 can easily be made into a large-capacity battery. Battery faults (for instance, abnormal heat generation) that accompany large current transfers during shorts are likely to occur in large-capacity batteries, and hence the present invention is particularly useful when used in such batteries (in particular, batteries having a battery capacity of 10 Ah or more). In a preferred application of the technology disclosed herein, for instance, the material of the battery case is a metallic material. Preferably, the present invention is used with battery cases made of aluminum or comprising nickel-plated copper.

The present invention will be explained below in further detail on the basis of Test examples 1 to 4.

Manufacture of a Positive Electrode Sheet

LiFePO₄ powder was used as the positive electrode active material. In Test example 1 there was prepared a paste for positive electrode active material layers by mixing the positive electrode active material powder, acetylene black (AB) as a conductive material, and polyvinylidene fluoride (PVdF) as a binder, to a weight ratio of 85:5:10, in N-methylpyrrolidone (NMP). This paste for positive electrode active material layers was applied, to a band shape, onto both faces of an elongate sheet-like aluminum foil (positive electrode collector 12, thickness 15 μm), followed by drying, to produce thereby the positive electrode sheet 10 having the positive electrode active material layer 14 on both faces of the positive electrode collector 12. After drying, roll pressing was carried out to a thickness of the positive electrode active material layer 14 of 50 μm on one face (100 μm on both faces), to adjust the density of the positive electrode active material layer to 2.2 g/cm³.

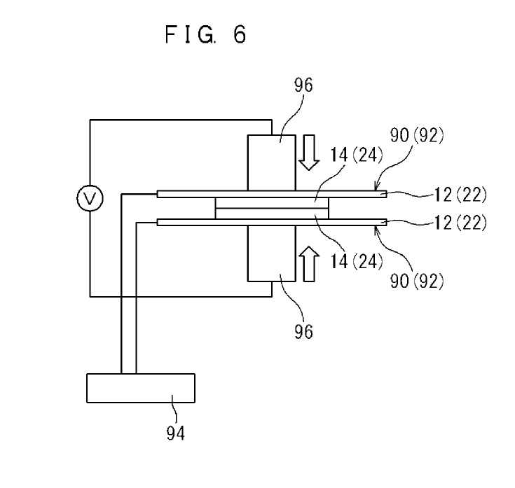

Measurement of the electric resistance value of the positive electrode The electric resistance value of the positive electrode active material layer (thickness 100 μm, density: 2.2 g/cm³) was measured. The measurement of the electric resistance value was carried out using the device illustrated in FIG. 6. Firstly, two test pieces 90 in which a 50 μm-thick (density: 2.2 g/cm³) positive electrode active material layer 14 was provided on one face of the positive electrode collector 12, was produced in the same way as the above-described positive electrode sheet. Next, the positive electrode active material layers 14 of the two test pieces 90 were superposed on each other, the stack was clamped between a pair of voltage measurement terminals 96, and then the resistance value was measured on the basis of the voltage change upon flow of current from a current application device 94 while a load of 20 kg/cm² was being applied from above and below the voltage measurement terminals, as illustrated in FIG. 6. The electric resistance value (measurement resistance value R× contact surface area S) was calculated on the basis of the obtained measurement resistance value R, and the contact surface area S (about 2 cm²) between the voltage measurement terminal and the test piece. In Test example 1, the electric resistance value of the positive electrode active material layer was about 0.986 Ω·cm².

Manufacture of a Negative Electrode Sheet

Natural graphite powder was used as the negative electrode active material. A paste for negative electrode active material layers was prepared by mixing graphite powder, a styrene-butadiene copolymer (SBR) as a binder, and carboxymethyl cellulose (CMC) as a thickener, to a weight ratio of the foregoing materials of 95:2.5:2.5, in water. The paste for negative electrode active material layers was applied, to a band shape, onto both faces of an elongate sheet-like copper foil (negative electrode collector 22, thickness 15 μm), followed by drying (drying temperature 80° C.), to produce the negative electrode sheet 20 in which the negative electrode active material layer 24 was provided on both faces of the negative electrode collector 22. After drying, roll pressing was carried out to a thickness of the negative electrode active material layer 24 of 40 μm on one face (80 μm on both faces).

Measurement of the Electric Resistance Value of the Negative Electrode

The electric resistance value of the negative electrode active material layer 24 (thickness 80 μm) was measured. The measurement of the electric resistance value was carried out in accordance with the same method for measuring the electric resistance value of the positive electrode active material layer described above. Specifically, two test pieces 92 in which a 40 μm-thick negative electrode active material layer 24 was provided on one face of the negative electrode collector 22, were produced in the same way as the above-described negative electrode sheet. Next, the negative electrode active material layers 24 of the two test pieces 92 were superposed on each other, the resulting stack was clamped between a pair of voltage measurement terminals 96, and then the resistance value was measured on the basis of the voltage change upon flow of current from the current application device 94 while a load of 20 kg/cm² was being applied from above and below the voltage measurement terminals 96, as illustrated in FIG. 6. The electric resistance value was calculated on the basis of the obtained measurement resistance value R, and the contact surface area S (about 2 cm²) between the voltage measurement terminal and the test piece. In Test example 1, the electric resistance value of the negative electrode active material layer was about 0.0099 Ω·cm². The multiple (hereafter referred to as resistance ratio) of the electric resistance value of the positive electrode active material layer 14 with respect to the electric resistance value of the negative electrode active material layer 24, was about 99.6-fold, as worked out from the above results.

Construction of a Lithium Ion Battery

A lithium ion battery for testing was produced using the positive electrode sheet 10 and the negative electrode sheet 20 produced above, by electrically connecting, to the battery case 50, the negative electrode side in which the electrode active material layer had a relatively small electric resistivity. The lithium ion battery for testing was produced as described below.

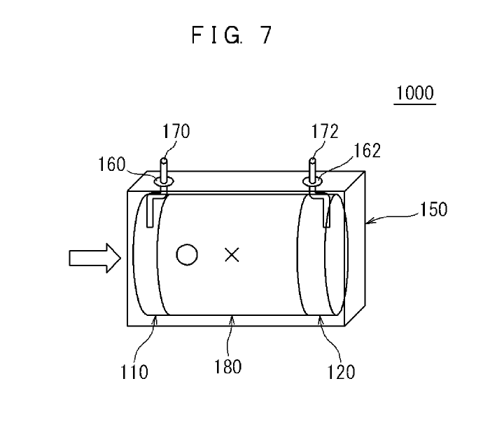

The positive electrode sheet 10 and the negative electrode sheet 20 were wound together, with two separator sheets 40 (16 μm-thick porous polyethylene films) interposed in between. The resulting wound body was squashed from both sides, to produce a flat-shaped wound electrode body 80. The wound electrode body 80 thus obtained was assembled, together with a non-aqueous electrolyte solution, into a battery case made of nickel-plated copper (thickness 1 mm), to construct thereby a lithium ion battery for testing 15 cm long×2 cm wide×10 cm high illustrated in FIG. 7. In FIG. 7, the reference numeral 110 denotes a positive electrode, the reference numeral 120 denotes a negative electrode, the reference numeral 180 denotes a electrode body, the reference numeral 170 denotes a positive electrode terminal, the reference numeral 172 denotes a negative electrode terminal, the reference numeral 150 denotes a battery case, the reference numeral 160 denotes a resin-made insulating gasket, and the reference numeral 162 denotes a copper-made conductive spacer.

In Test example 1 a lithium ion battery was constructed by conductively connecting the negative electrode side (i.e. the electrode on the side at which the electric resistance value of the electrode active material layer is relatively small) to the battery case 150. Specifically, the negative electrode terminal 172 was fixed to the battery case 150 by way of the copper-made conductive spacer 162, to electrically connect thereby the negative electrode 20 and the battery case 150. The positive electrode terminal 170 was fixed to the battery case 150 by way of the resin-made gasket 160, to electrically insulate thereby the positive electrode 10 from the battery case 150. As the non-aqueous electrolyte solution there was used a solution containing about 1 mol/L of LiPF₆, as a supporting salt, in a mixed solvent of ethylene carbonate (EC), dimethyl carbonate (DMC) and ethyl methyl carbonate (EMC) at a volume ratio of 3:3:4. Thereafter, an initial charge and discharge treatment was carried out in accordance with ordinary methods, to yield a lithium ion battery for testing. The theoretical capacity of this lithium ion battery was 15 Ah.

In Test examples 2 to 4 there were constructed lithium ion batteries by modifying, as given it table 1 below, the electric resistance value of the positive and negative electrodes, the resistance ratio multiple (electric resistance value of the positive electrode active material layer/ electric resistance value of the negative electrode active material layer). The electric resistance value of the positive electrode active material layer was adjusted by modifying the addition proportion of the conductive agent (AB) and the density of the mix. In Test example 2, specifically, pressing was carried out in such a manner that the weight ratio of positive electrode active material, AB and PVdF was modified to 85:2:13, and the density of the positive electrode active material was 2.1 g/cm³. In Test example 3, specifically, pressing was carried out in such a manner that the weight ratio of positive electrode active material, AB and PVdF was modified to 85:2:13, and the density of the positive electrode active material was 1.9 g/cm³. In Test example 4, specifically, pressing was carried out in such a manner that the weight ratio of positive electrode active material, AB and PVdF was modified to 85:10:5, and the density of the positive electrode active material was 2.4 g/cm³. The lithium ion batteries were constructed in the same way as in Test example 1, except that the resistance ratio between the positive and negative electrodes were modified as given in Table 1.

TABLE 1

| | Test example 1 | Test example 2 | Test example 3 | Test example 4 |
|---|---|---|---|---|
| | (Comparative | (Comparative | (Comparative | (Comparative |
| | example 1) | example 2) | example 3) | example 4) |
| Electric | 0.986 Ω · cm² | 5.54 Ω · cm² | 9.95 Ω · cm² | 0.152 Ω · cm² |
| resistance value | | | | |
| of positive | | | | |
| electrode | | | | |
| Electric | 0.0099 Ω · cm² | 0.0108 Ω · cm² | 0.0098 Ω · cm² | 0.0088 Ω · cm² |
| resistance value | | | | |
| of negative | | | | |
| electrode | | | | |
| Resistance ratio | 99.6-fold | 513.0-fold | 1015.3-fold | 17.3-fold |

In Comparative examples 1 to 4 there were constructed lithium ion batteries having the same configuration as those of Test examples 1 to 4 as regards the electric resistance value of the positive and negative electrodes, the resistance ratio multiple (electric resistance value of the positive electrode active material layer/electric resistance value of the negative electrode active material layer). In Comparative examples 1 to 4, however, the battery case was made up of aluminum, and the positive electrode side (i.e. electrode on the side at which the electric resistance value of the electrode active material layer was relatively large) was conductively connected to the battery case). The lithium ion batteries were constructed in the same way as in Test examples 1 to 4, but herein the positive electrode side was conductively connected to the battery case.

Stability Test

The lithium ion batteries thus produced in Test examples 1 to 4 and Comparative examples 1 to 4 were charged up to a charging upper limit voltage (4.2 V) at a current value that enabled supplying, in five hours, the battery capacity predicted on the basis of the positive electrode theoretical capacity (i.e. current value of ⅕C), and were further charged until reaching 1/10 of the initial current value at constant voltage. The charged lithium ion batteries were then subjected to a crush test, a drop test and a nail penetration test. In the crush test, the charged lithium ion batteries were squashed in the direction of the arrow of FIG. 7 under a pressure force of 20 kN (10 mm/sec), using a compression device fitted with a semi-circular iron recorded the leading end of which had a radius of 3 cm, such that the pressure force acting on the battery was discontinued once there was obtained a 50% deformation. In the drop test, the charged lithium ion batteries were dropped onto a concrete floor from a height of 15 m. In the nail penetration test, a 3 mm-diameter iron nail was driven through the area of the center (site indicated by x in FIG. 7) of the charged lithium ion batteries at a speed of 10 mm/sec). The test temperature in the stability test was 25° C. and 60° C. The battery temperature (highest-reached temperature) was measured, in the various tests, by way of a thermocouple affixed to the outer surface of the battery case.

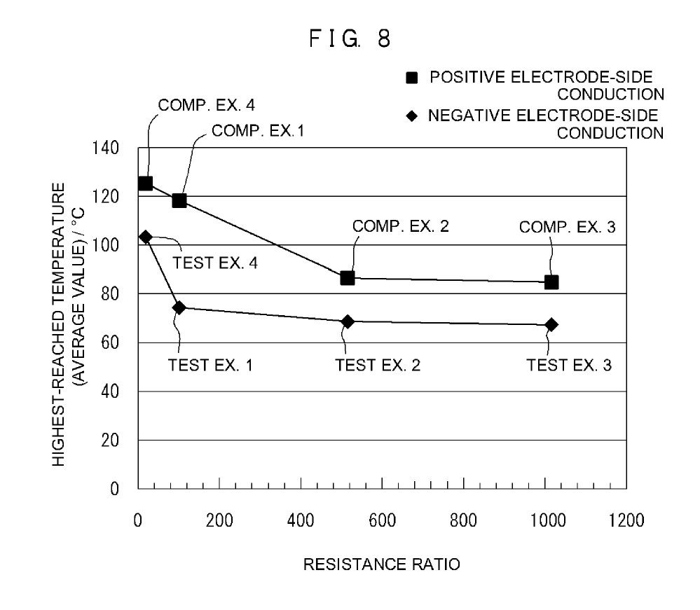

The results are given Tables 2 to 5. Table 2 shows the results of Test example 1 and Comparative example 1. Table 3 shows the results of Test example 2 and Comparative example 2. Table 4 shows the results of Test example 3 and Comparative example 3. Table 5 shows the results of Test example 4 and Comparative example 4. The average value of the highest-reached temperature during the tests was calculated for each of the Test examples 1 to 4 and the Comparative examples 1 to 4, and there was plotted the relationship between highest-reached temperature (average value), and the resistance ratio multiple of the positive and negative electrodes (electric resistance value of the positive electrode active material layer/ electric resistance value of the negative electrode active material layer). The results are illustrated in FIG. 8.

TABLE 2

| | | | | | Result | |
|---|---|---|---|---|---|---|
| | | | | | | Highest- |
| | Test conditions | | | | Highest- | reached |
| | Case | Conduction | | | reached | temperature |
| | material | with case | Test item | Temperature | temperature | (average) |
| Test | Ni-plated | Negative | Crushing | 25° C. | 73° C. | 75° C. |
| example 1 | Fe | electrode | | | | |
| | Ni-plated | Negative | Crushing | 60° C. | 130° C. | |
| | Fe | electrode | | | | |
| | Ni-plated | Negative | Drop | 25° C. | 33° C. | |
| | Fe | electrode | | | | |
| | Ni-plated | Negative | Drop | 60° C. | 68° C. | |
| | Fe | electrode | | | | |
| | Ni-plated | Negative | Nail | 25° C. | 67° C. | |
| | Fe | electrode | penetration | | | |
| | Ni-plated | Negative | Nail | 60° C. | 81° C. | |
| | Fe | electrode | penetration | | | |
| Comparative | Al | Positive | Crushing | 25° C. | 99° C. | 119° C. |
| example 1 | | electrode | | | | |
| | Al | Positive | Crushing | 60° C. | 138° C. | |
| | | electrode | | | | |
| | Al | Positive | Drop | 25° C. | 100° C. | |
| | | electrode | | | | |
| | Al | Positive | Drop | 60° C. | 120° C. | |
| | | electrode | | | | |
| | Al | Positive | Nail | 25° C. | 115° C. | |
| | | electrode | penetration | | | |
| | Al | Positive | Nail | 60° C. | 146° C. | |
| | | electrode | penetration | | | |

TABLE 3

| | | | | | Result | |
|---|---|---|---|---|---|---|
| | | | | | | Highest- |
| | Test conditions | | | | Highest- | reached |
| | Case | Conduction | | | reached | temperature |
| | material | with case | Test item | Temperature | temperature | (average) |
| Test | Ni-plated | Negative | Crushing | 25° C. | 68° C. | 69° C. |
| example 2 | Fe | electrode | | | | |
| | Ni-plated | Negative | Crushing | 60° C. | 102° C. | |
| | Fe | electrode | | | | |
| | Ni-plated | Negative | Drop | 25° C. | 36° C. | |
| | Fe | electrode | | | | |
| | Ni-plated | Negative | Drop | 60° C. | 70° C. | |
| | Fe | electrode | | | | |
| | Ni-plated | Negative | Nail | 25° C. | 62° C. | |
| | Fe | electrode | penetration | | | |
| | Ni-plated | Negative | Nail | 60° C. | 77° C. | |
| | Fe | electrode | penetration | | | |
| Comparative | Al | Positive | Crushing | 25° C. | 81° C. | 87° C. |
| example 2 | | electrode | | | | |
| | Al | Positive | Crushing | 60° C. | 98° C. | |
| | | electrode | | | | |
| | Al | Positive | Drop | 25° C. | 76° C. | |
| | | electrode | | | | |
| | Al | Positive | Drop | 60° C. | 88° C. | |
| | | electrode | | | | |
| | Al | Positive | Nail | 25° C. | 86° C. | |
| | | electrode | penetration | | | |
| | Al | Positive | Nail | 60° C. | 95° C. | |
| | | electrode | penetration | | | |

TABLE 4

| | | | | | Result | |
|---|---|---|---|---|---|---|
| | | | | | | Highest- |
| | Test conditions | | | | Highest- | reached |
| | Case | Conduction | | | reached | temperature |
| | material | with case | Test item | Temperature | temperature | (average) |
| Test | Ni-plated | Negative | Crushing | 25° C. | 66° C. | 68° C. |
| example 3 | Fe | electrode | | | | |
| | Ni-plated | Negative | Crushing | 60° C. | 96° C. | |
| | Fe | electrode | | | | |
| | Ni-plated | Negative | Drop | 25° C. | 33° C. | |
| | Fe | electrode | | | | |
| | Ni-plated | Negative | Drop | 60° C. | 67° C. | |
| | Fe | electrode | | | | |
| | Ni-plated | Negative | Nail | 25° C. | 63° C. | |
| | Fe | electrode | penetration | | | |
| | Ni-plated | Negative | Nail | 60° C. | 80° C. | |
| | Fe | electrode | penetration | | | |
| Comparative | Al | Positive | Crushing | 25° C. | 79° C. | 85° C. |
| example 3 | | electrode | | | | |
| | Al | Positive | Crushing | 60° C. | 91° C. | |
| | | electrode | | | | |
| | Al | Positive | Drop | 25° C. | 72° C. | |
| | | electrode | | | | |
| | Al | Positive | Drop | 60° C. | 87° C. | |
| | | electrode | | | | |
| | Al | Positive | Nail | 25° C. | 84° C. | |
| | | electrode | penetration | | | |
| | Al | Positive | Nail | 60° C. | 98° C. | |
| | | electrode | penetration | | | |

TABLE 5

| | | | | | Result | |
|---|---|---|---|---|---|---|
| | | | | | | Highest- |
| | Test conditions | | | | Highest- | reached |
| | Case | Conduction | | | reached | temperature |
| | material | with case | Test item | Temperature | temperature | (average) |
| Test | Ni-plated | Negative | Crushing | 25° C. | 101° C. | 104° C. |
| example 4 | Fe | electrode | | | | |
| | Ni-plated | Negative | Crushing | 60° C. | 120° C. | |
| | Fe | electrode | | | | |
| | Ni-plated | Negative | Drop | 25° C. | 79° C. | |
| | Fe | electrode | | | | |
| | Ni-plated | Negative | Drop | 60° C. | 119° C. | |
| | Fe | electrode | | | | |
| | Ni-plated | Negative | Nail | 25° C. | 96° C. | |
| | Fe | electrode | penetration | | | |
| | Ni-plated | Negative | Nail | 60° C. | 109° C. | |
| | Fe | electrode | penetration | | | |
| Comparative | Al | Positive | Crushing | 25° C. | 105° C. | 126° C. |
| example 4 | | electrode | | | | |
| | Al | Positive | Crushing | 60° C. | 140° C. | |
| | | electrode | | | | |
| | Al | Positive | Drop | 25° C. | 107° C. | |
| | | electrode | | | | |
| | Al | Positive | Drop | 60° C. | 125° C. | |
| | | electrode | | | | |
| | Al | Positive | Nail | 25° C. | 126° C. | |
| | | electrode | penetration | | | |
| | Al | Positive | Nail | 60° C. | 154° C. | |
| | | electrode | penetration | | | |

As FIG. 8 shows, the highest-reached temperature (average value) was significantly lower in Test examples 1 to 4, where the negative electrode side was conductively connected to the battery case, as compared with Comparative examples 1 to 4, where the positive electrode side was conductively connected to the battery case. The results indicate that a lithium secondary battery having higher stability can be provided by conductively connecting the negative electrode side (i.e. electrode on the side at which the electric resistance value of the electrode active material layer is relatively small) to the battery case. A comparison between Test examples 1 to 4 showed that the highest-reached temperature (average value) dropped significantly when the resistance ratio multiple of the positive and negative electrodes (electric resistance value of the positive electrode active material layer/electric resistance value of the negative electrode active material layer) exceeded 90-fold. In Test examples 2 and 3, in particular, where the resistance ratio multiple exceeded 500-fold the highest-reached temperature (average value) was about 70° C. or lower, indicative of increased stability. The tested batteries could reach a very low highest-reached temperature (average value) of 68° C. or lower, by setting the resistance ratio multiple to 1000-fold or more (Test example 3). The above results indicated that abnormal heat generation in a battery could be suppressed more effectively by adjusting the resistance ratio multiple (electric resistance value of the positive electrode active material layer/electric resistance value of the negative electrode active material layer) to 90-fold or more (preferably 500-fold or more, more preferably 1000-fold or more).

The present invention has been explained based on appropriate embodiments, but the embodiments are not limiting features and, needless to say, are amenable to various modifications. In the above-described examples, for instance, the electrode on the side conductively connected to the case is the negative electrode 20, the electrode on the side not conductively connected to the case is the positive electrode 10, and the electric resistivity of the positive electrode active material layer 14 is 90-fold or more greater than the electric resistivity of the negative electrode active material layer 24, but the present invention is not limited thereto. For instance, the electrode on the side conductively connected to the case may be the positive electrode, the electrode on the side not conductively connected to the case may be the negative electrode, and the electric resistivity of the negative electrode active material layer may be 90-fold or more greater than the electric resistivity of the positive electrode active material layer. In this case as well, battery faults caused by, for instance, heat generation in the battery during shorts can be suppressed by causing the electrode on the side at which the electric resistivity of the electrode active material layer is relatively small (herein, the positive electrode) to be conductively connected beforehand to the battery case. In the present embodiment an example of a lithium ion secondary battery has been explained where the flat-shaped wound electrode body 80 is housed in the square-type case 50, but the present invention is not limited thereto. For instance, the present invention may also be used in a lithium ion secondary battery having a configuration where a cylindrical wound electrode body is housed in a tubular battery case.

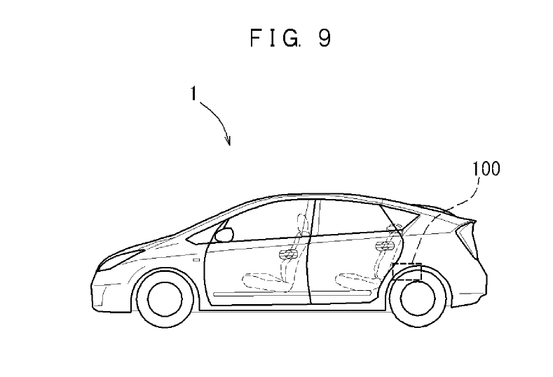

The battery 100 according to the present invention boasts good battery characteristics in that battery faults (abnormal heat generation and the like) during shorts are suppressed, as described above. Therefore, the battery 100 of the present invention can be appropriately used as a power source for motors (electric motors) installed in vehicles, in particular automobiles or the like. The present invention, therefore, provides a vehicle 1 as illustrated schematically in FIG. 9 (typically, an automobile, in particular an automobile provided with an electric motor, for instance a hybrid automobile, an electric automobile or a fuel-cell automobile) that is equipped with a power source in the form of such a lithium secondary battery (in particular, a lithium ion battery) 100 (typically, a battery pack in which a plurality of batteries are connected in series).

### INDUSTRIAL APPLICABILITY

By virtue of the features, the present invention can provide a highly reliable lithium secondary battery in which battery faults (for instance, abnormal heat generation) during shorts can be suppressed.

1. A lithium secondary battery, comprising:
an electrode body that is made up of a positive electrode having a positive electrode active material layer that has a positive electrode active material on the surface of a positive electrode collector, a negative electrode having a negative electrode active material layer that has a negative electrode active material on the surface of a negative electrode collector, and a separator disposed between the positive electrode and the negative electrode; and
a metallic battery case that houses the electrode body together with an electrolyte solution, wherein
either the positive electrode or the negative electrode is electrically connected to the battery case; and
an electric resistance value of the electrode active material layer of the electrode on a side not conductively connected to the case is 90-fold or greater than an electric resistance value of the electrode active material layer of the electrode on a side conductively connected to the case.

2. The lithium secondary battery according to claim 1, wherein the electric resistance value of the electrode active material layer on the side not conductively connected to the case is 500-fold or greater than the electric resistance value of the electrode active material layer on the side conductively connected to the case.

3. The lithium secondary battery according to claim 1, wherein the electric resistance value of the electrode active material layer on the side not conductively connected to the case is 1000-fold or greater than the electric resistance value of the electrode active material layer on the side conductively connected to the case.

4. The lithium secondary battery according to claim 1, wherein the electric resistance value of the electrode active material layer on the side not conductively connected to the case ranges from 1 Ω·cm² to 10 Ω·cm².

5. The lithium secondary battery according to claim 1, wherein
the electrode on the side not conductively connected to the case is a positive electrode, and
the positive electrode has, as a positive electrode active material, an olivine-type phosphate compound represented by formula LiMPO₄ (where M includes at least one metal element selected from the group consisting of Fe, Ni and Mn).

6. The lithium secondary battery according to claim 1, wherein
the electrode body is a flat-shaped wound electrode body, and
the battery case is a square-type case capable of housing the flat-shaped wound electrode body.

7. The lithium secondary battery according to claim 1, wherein the battery capacity of the lithium secondary battery is 10 Ah or higher.

8. A vehicle, provided with the lithium secondary battery according to claim 1.
